(19) United States
(12) Patent Application Publication
(10) Pub. No.: US 2008/0235037 A1
(43) Pub. Date: Sep. 25, 2008

(54) Bonus Point System to Create a Profile of a Person

(75) Inventors: Thomas Portele, Bonn (DE); Jan Kneissler, Aachen (DE); Holger R. Scholl, Herzogenrath (DE); Georg Kurz-Bauer, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,531

(22) PCT Filed: Jan. 27, 2005
(86) PCT No.: PCT/IB2005/050353

§ 371 Date: Jul. 28, 2006

(30) Foreign Application Priority Data
Jan. 30, 2004 (EP) 04100344.3

(51) Int. Cl. G06Q 99/00

(52) U.S. Cl. 705/1

(57) ABSTRACT

This invention relates to method and a system for collecting and managing bonus points in order to generate a personal profile based on said bonus points, wherein the bonus points are related to activities performed by a person. Therefore, the personal profile is obtained by accessing a manager server where the bonus points are stored and viewing the number of points in a certain activity.

The present invention relates to a system adapted to create a personal profile of a person by means of collecting bonus points relating to different activities of the person.

The concept of collecting points and using them to obtain some kind of price is well known. Accordingly, what characterizes the current point systems is that they are solely business oriented. A well known example is the flying point system offered by some of the flying companies, where a person earns flying points by flying with the airline, or even for using a hotel owned by the airline company. Another example is a supermarket that gives the client points, which later on may be used as coupon points. This point system has been extended further through a wireless communication. An example is a Bluetooth-based system that allows shoppers to use their cell phones to wirelessly send discount coupons to, or collect bonus points from, cash register (Computer world Singapore, vol. 8, Issue No. 14, 1-21. February 2002).

The stored information are not being used very efficiently and a further problem is that the stored information relating to the point account is very limited, i.e. the stored information relates as an example to how many points a person has earned in total through supermarket shopping at a specific supermarket. Further the known point systems are typically dedicated point systems used separated from each other.

It is the object of the present invention to solve the before mentioned problems.

According to the first aspect the present invention relates to a method for collecting and managing bonus points in order to generate a personal profile based on said bonus points, wherein said bonus points are related to activities performed by a person, wherein the method comprises the steps of:
transmitting at least one bonus point from a collecting device comprising information relating to a specific activity performed by the person together with an identification of said person, and
receiving and storing said at least one transmitted bonus point based on said identification of said person, whereby, by accessing said bonus point a personal profile can be generated.

Thereby the bonus points are stored at the same place, such as at a central server, and wherein the stored data can be used effectively to extract data to generate a personal profile of the person or to used them as bonus coupons. Furthermore, the stored bonus points can comprise a plurality of categories, wherein each category represents one or more activity. Accordingly, the category representing the activity for food is preferably divided into plurality of sub-categories, wherein the sub-categories are divided into plurality of sub-activities within the food activity. An example of sub-activities can be wine, beer, meat etc. The result is that more information are obtained for each person.

This stored bonus points can be accessed through a mobile device or through a stationary device. Accordingly, a person can as an example demonstrate his skills in one or more activities by entering the bonus points, either through a mobile device or from a stationary device, and extract the number of points in said one or more activities.

An activity is as an example sports, science, wine drinking, food, wherein the received bonus points may be adapted to reflect the skills of the person in said activities and thereby create a personal profile of the person. After receiving said bonus points they are transferred from said collecting device where they are collected to a manager server where they are stored and managed.

In one embodiment the bonus points are collected locally at the collector device prior to transmitting said bonus points and transmitted as a bonus point data package, wherein transmitting said bonus point data package may be done in predefined time intervals, such as twice every day or every second hour as an example. In one embodiment the data package comprises bonus points from a number of persons.

Preferably, the bonus points further comprise information relating to the location where the activity was performed. The activity could be buying food at a three stars restaurant, wherein the location determines the type of activity, i.e. food activity, and the time simply indicates the time at which the activity took place.

According to the second aspect the present invention relates to a collector device to be used in a system for collecting and managing bonus points in order to generate a personal profile, wherein said bonus points are related to activities performed by a person, wherein said collector device comprises:
means for receiving said bonus points based on the activities performed by said person, and
means for transmitting said bonus points together with an identification of said person to a manager server, wherein said manager server is adapted for receiving and storing said bonus points based on said received identification of said person, whereby, by accessing said manager server, said bonus points can be used to generate a personal profile.

In one embodiment the collector device is a mobile device, such as a cellular phone. In another embodiment the collector device is a stationary device, such as a regular computer with a transmitting device and optionally a receiving device. Preferably, the collector device comprises storage means, and/or means for determining the location on which the activity was performed, such as a GPS system and/or means for determining the time at which the activity was performed.

In another preferred embodiment the transaction between said collector device to said manager server is given a code being representative to the collector device and the type of activity.

In still another embodiment the bonus points are collected locally prior to transmitting the bonus points to the manager server.

In yet another embodiment an XP-interchange protocol is provided at the collecting device and the manager server to support the transmission between said collector device and said manager server.

According to the third aspect the present invention relates to a manager server to be used in a system for collecting and managing bonus points in order to generate a personal profile, wherein said bonus points are related to activities performed by a person, wherein said manager server comprises:
means for receiving said bonus points together with an identification of said person from a collector device, wherein said collector device is adapted for receiving and transmitting said bonus points based on the activities performed by said person together with an identification of said person to a manager server, and
means for storing said bonus points based on said identification of said person, whereby, by accessing said manager server, said bonus points can be used to generate a personal profile.

According to the fourth aspect the present invention relates to a system for collecting and managing bonus points in order to generate a personal profile based on said bonus points, wherein said bonus points are related to activities performed by a person, said system comprising:
a collector device comprising:
   means for receiving said bonus points based on the activities performed by said person,
   means for transmitting said bonus points together with an identification of said person to a manager server,
a manager server comprising:
   means for receiving said bonus points together with an identification of said person from said collector device,
   means for storing said bonus points based on said identification of said person,
means for accessing said bonus points based on said identification of said person to obtain a personal profile of said person.

In the following preferred embodiments of the invention will be described referring to figures, where

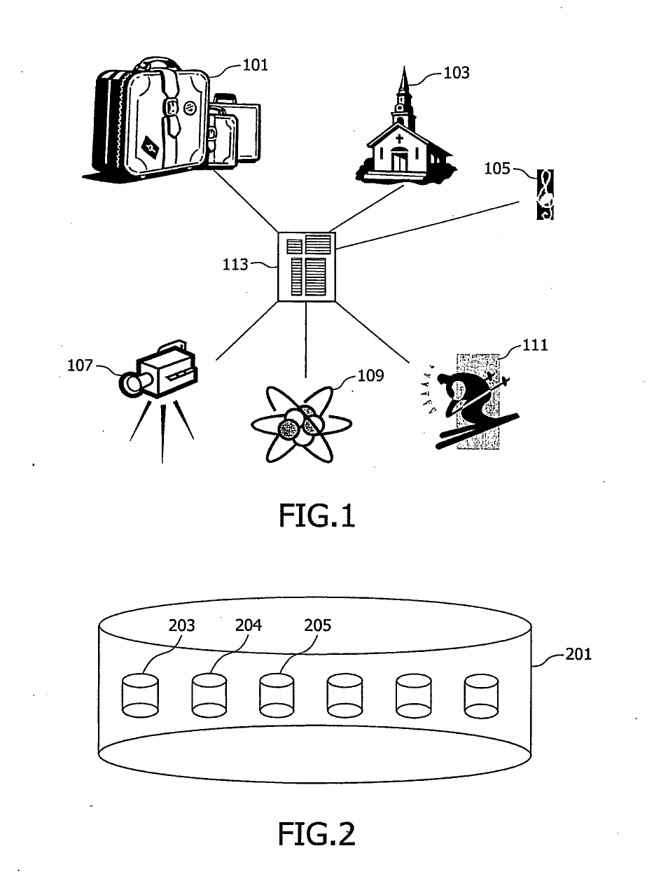

FIG. 1 illustrates an example showing different activities where bonus points for different activities are collected at a manager server,

FIG. 2 shows a storage means being divided into different categories relating to different activities,

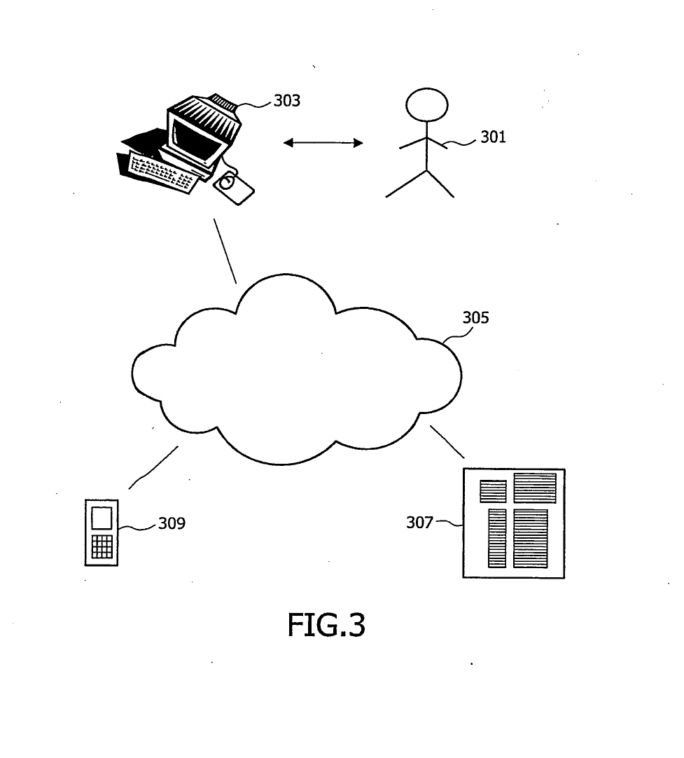

FIG. 3 shows one embodiment of a system for collecting and manager bonus points in order to generate a personal profile,

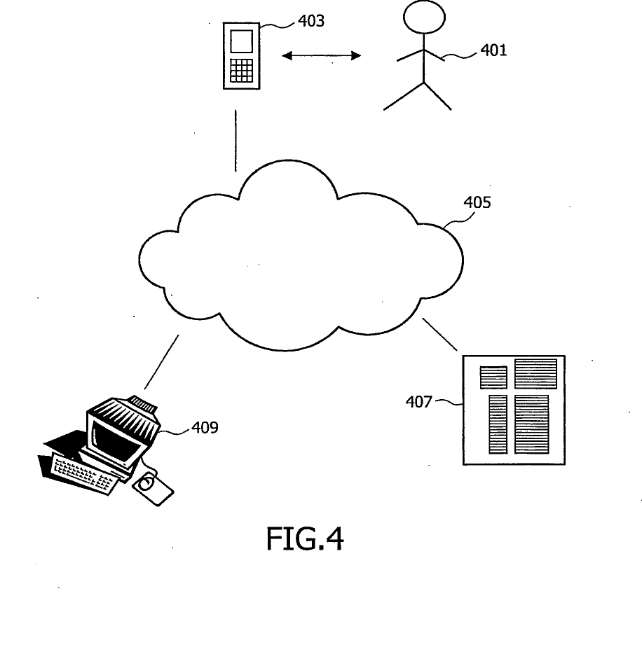

FIG. 4 shows another embodiment of a system for collecting and manager bonus points in order to generate a personal profile,

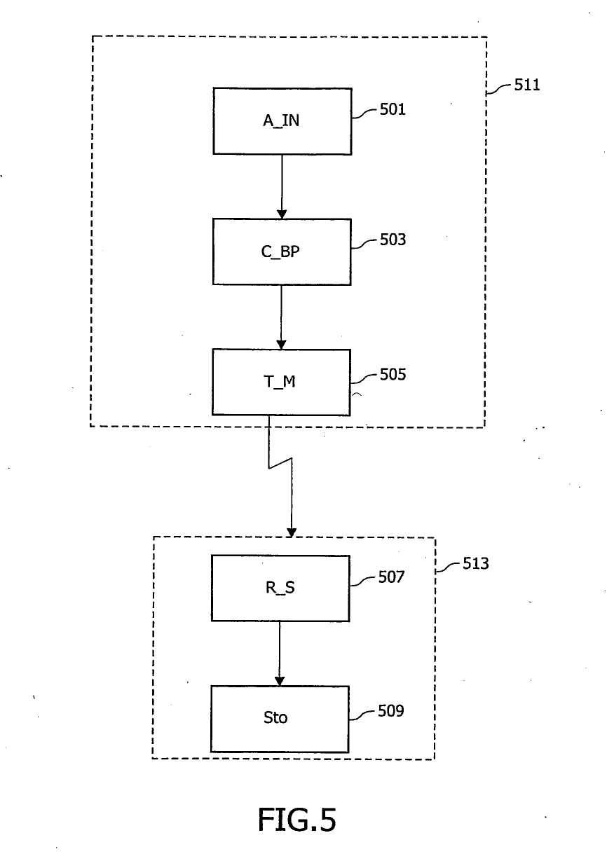

FIG. 5 illustrates a method for collecting and manager bonus points in order to generate a personal profile, and

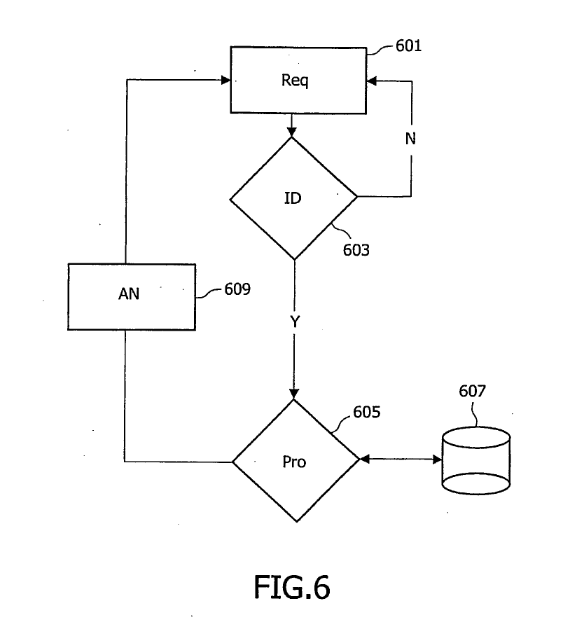

FIG. 6 illustrates one embodiment of how to access the manager server from the collecting device.

FIG. 1 illustrates an example showing six different categories whereby each category stands for one or more activity that gives bonus points, which are collected at a manager server 113. The categories shown in FIG. 1 represent the following activities: travelling 101, religion 103, music 105, movie 107, science 109 and sport 111.

Collecting the bonus points by performing an activity could as an example occur when paying the flight ticket or a hotel when the category is travelling 101, or when paying for a movie ticket if the category is movie 107. In one embodiment the various categories comprise different activities that can be divided into different sub-categories representing different sub-activities. An example of such sub-category is a climbing, wherein the activity climbing could be a sub-category under the main category sport. Another example of such sub-category is different type of movies, e.g. action movies, drama etc. under the main category movie 107.

In one preferred embodiment the bonus points are given for two or more activities simultaneously. An example is a person who is going on a sky trip in another country, where the person earns bonus points for both the travelling activity as well as for the sport activity.

The bonus points could be collected through stationary bonus providers. As an example, such stationary bonus provider could be located on the top of the mountain so that when a climber has reached a mountain he receives bonus points for the sport activity.

After receiving bonus points for an activity the points are transferred to a manager server 113 where they are stored. There are different ways to transmit the bonus point to said manager server 113. In the example of the climber, the bonus provider on the mountain could further comprise a transmitter to transmit the bonus points to the manager server 113 with the identification of the climber. If on the other hand the bonus provider is too far away from the manager server 113, the climber could use a mobile device to store said bonus for climbing up the mountain, and later transmit said stored bonus points to the manager server. In this case the bonus provider on the top of the mountain and/or the mobile device could be provided with location means, such as GPS, and preferably also the time of reaching the top of the mountain, to attach said data to the transmitted bonus points. In one embodiment, different mountains could give different number of bonus points. Accordingly, the more difficult the climbing is, the larger is the amount of received bonus points. In another example the bonus point provider is the cashier's desk after paying the movie ticket, and wherein the cashier's desk further comprises a transmitter to transmit the bonus points to the manager server.

The collected and stored bonus points are adapted to generate a personal profile of the person by accessing the bonus points through a mobile device or a stationary device. A person can as an example demonstrate his skills in one or more activities by entering the manager server, either through a mobile device or from a stationary device, and extract the number of points in said one or more activities. Another example is a person who has very much experience in a certain activity and thereby many experience points, and who enters a store, can be attended in a different way than someone who has a low number of activity points. Yet another example is a person applying for a job, wherein the bonus points are used to create a personal profile of the person. The job could be a service assistant in a wine store, and wherein the number of experience points in the activity related to wine is especially viewed.

The bonus points can also be used as coupon points in such a way that a person who has many bonus points in one activity is given a discount. This can as an example be the wine activity wherein the product is wine.

FIG. 2 shows the storage means 201 at the manager server side, where the bonus points are collected and stored. In this embodiment the storage means 201 is divided into several categories 203-205 representing different activities. As an example, the first category 203 could be representative for the travelling activity 101 shown in FIG. 1, the second category for the religion activity 103, the third category for the music activity 105 etc.

FIG. 3 shows one embodiment of a system for collecting and manager bonus points in order to generate a personal profile, wherein a person 301 performs an activity and a collector device 303, receives the bonus points and transmits the bonus points to a manager server 307, such as through a wireless transmission 305. At the manager server the bonus points are collected and stored.

Here, the collector device may further comprise a storage means, and/or means for determining the location on which the activity was performed, such as a GPS system, wherein the storage means could be adapted to collect some amount of points prior to transmitting the point to the manager server. Preferably, the collector device also comprises an internal clock to register the time at which the activity was performed.

In one embodiment the collector device 303 is programmed to transmit a bonus point data package comprising information relating to a number of people twice a day, or every two hours.

In another embodiment the transaction between the collector device 303 and the manager server 307 is given a code being representative to the collector device and the type of activity. As an example, the code could comprise the type of store where the person receives the bonus points, how expensive the store is and thereby the number of bonus points and the type of activity. Further information could be the identification of the person. The transmitted bonus points would therefore be collected at the manager server, under the correct categories and with the identification of the person.

The accessing of the bonus points stored at the manager server 307 is in FIG. 3 done through a mobile device 309, such as a cellular phone, where the actual points balance in one or more categories can be accessed. In one embodiment the point balance for other persons can be accessed.

FIG. 4 shows another embodiment of a system for collecting and managing bonus points in order to generate a personal profile, wherein the collector device 403 is mobile, and wherein the accessing of the bonus points stored at the manager server 407 is done through a stationary device 409. This stationary device could as an example be the computer system at the cashier's desk.

In one preferred embodiment the collector devices, 303, 403 and the manager servers 307, 407 in FIGS. 3 and 4 are provided with an XP-protocol, which is an interchange protocol and supports the transmission of bonus points between said devices. The XP protocol contains entries about time and place, the number of points, and the categories. Each transaction obtains a unique code. These locally induced transactions can later be sent to a manager server, wherein the unique transaction identification must be transmitted by the mobile or collector device to the manager server in order for the transaction to become valid. This would not relevant for a supermarket, but for a mountain top.

By accessing the central server the individual bonus point distribution can be obtained. Points from one category can be transformed to points in other categories (e.g. commercial bonus points from a supermarket can be converted to rebate points for a movie theater chain) if a specific indicator in the XP protocol is set (like “convertible to XXX.YYY.ZZZ” where XXX.YYY.ZZZ is a hierarchical category description).

In a situation where no sending device is available, a device can record GPS information, time, and an audiovisual recording of the environment which can be certified offline by the server using e.g. image recognition and sound analysis techniques. Audiovisual information can also be appended by the user (like a camcorder recording) for a user-specific experience diary that can be accessed via the central server.

FIG. 5 illustrates a method of collecting and managing bonus points in order to generate a personal profile. At the collecting device 511 side, information relating to an activity (A_IN) 501 is obtained together with an identification of the person, collected (C_BP) 503 and transmitted (T_M) 505. On the manager server side 513, the transmitted data are received (R_S) 507 and stored (Sto) 509. As mentioned before, prior to transmitting the bonus points relating to the specific activity, the bonus points can be collected locally at the collector device and transmitted as a bonus point data package. This transmission may be performed immediately after collecting the points, or at some later time, wherein a bonus point data package would accordingly be transmitted, eventually comprising bonus points from a number of persons.

FIG. 6 illustrates one embodiment of accessing the manager server from the collecting device, comprising a request (Req) 601 from a person to access one or more categories in the manager server and to obtain the actual bonus point balance. The identification code (ID) 603 is requested. If the correct code is given, the request will be processed by a processing means (Pro) at 605 the manager server, which extracts the requested data, i.e. the bonus point balance for one or more activities, from the storage means 607. Otherwise the request is denied. The answer to the request (AN) 609 will subsequently be transmitted to the person.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method of collecting and managing bonus points in order to generate a personal profile based on said bonus points, wherein said bonus points are related to activities performed by a person, wherein the method comprises the steps of:
transmitting at least one bonus point from a collecting device comprising information relating to specific activity performed by the person together with an identification of said person, and
receiving and storing said at least one transmitted bonus point based on said identification of said person, whereby, by accessing said bonus points, a personal profile can be generated.

2. A method according to claim 1, wherein, prior to transmitting said bonus points relating to said specific activity, the bonus points are collected locally at the collector device and transmitted as a bonus point data package.

3. A method according to claim 2, wherein transmitting said bonus point data package is performed in predefined time intervals.

4. A method according to claim 2, wherein the data package comprises bonus points from a number of persons.

5. A method according to claim 1, wherein the bonus point further comprises information relating to the location on which the activity was performed.

6. A method according to claim 1, wherein the bonus point further comprises information relating to the time at which the activity was performed.

7. A collector device to be used in a system for collecting and managing bonus points in order to generate a personal profile, wherein said bonus points are related to activities performed by a person, wherein said collector device comprises:
means for receiving said bonus points based on the activities performed by said person, and
means for transmitting said bonus points together with an identification of said person to a manager server, wherein said manager server is adapted for receiving and storing said bonus points based on said received identification of said person, whereby, by accessing said manager server, said bonus points can be used to generate a personal profile.

8. A collector device according to claim 7, wherein the collector device is a mobile device.

9. A collector device according to claim 7, wherein the collector device further comprises storage means.

10. A collector device according to claim 7, wherein the collector device further comprises means for determining the location on which the activity was performed.

11. A collector device according to claim 7, wherein the collector device further comprises means for determining the time at which the activity was performed.

12. A collector device according to claim 7, wherein the transaction between said collector device to said manager server is given a code being representative to the collector device and the type of activity.

13. A collector device according to claim 7, wherein the bonus points are collected locally prior to transmitting the bonus points to the manager server.

14. A collector device according to claim 7, wherein an XP-protocol is used to provide the transmission between said collector device and said manager server.

15. A manager server to be used in a system for collecting and managing bonus points in order to generate a personal profile, wherein said bonus points are related to activities performed by a person, wherein said manager server comprises:
means for receiving said bonus points together with an identification of said person from a collector device, wherein said collector device is adapted for receiving and transmitting said bonus points based on the activities performed by said person together with an identification of said person to a manager server, and
means for storing said bonus points based on said identification of said person, whereby, by accessing said manager server, said bonus points can be used to generate a personal profile.

16. A system for collecting and manager bonus points in order to generate a personal profile based on said bonus points, wherein said bonus points are related to activities performed by a person, said system comprising:
a collector device comprising:
means for receiving said bonus points based on the activities performed by said person,
means for transmitting said bonus points together with an identification of said person to a manager server,
a manager server comprising:
means for receiving said bonus points together with an identification of said person from said collector device,
means for storing said bonus points based on said identification of said person,
means for accessing said bonus points based on said identification of said person to obtain a personal profile of said person.
